(19) United States
(12) Patent Application Publication
(10) Pub. No.: US 2019/0011273 A1
(43) Pub. Date: Jan. 10, 2019

(54) SYSTEM FOR OPTIMISING DRIVER AND VEHICLE PERFORMANCE

(71) Applicant: FORD GLOBAL TECHNOLOGIES, LLC, Dearborn, MI (US)

(72) Inventors: Richard Andrew POWELL, Gravesend (GB); Owen Fraser WOOD, Billericay (GB); Jonathan SCOTT, Chelmsford (GB)

(73) Assignee: FORD GLOBAL TECHNOLOGIES, LLC, Dearborn, MI (US)

(21) Appl. No.: 16/031,760

(22) Filed: Jul. 10, 2018

(30) Foreign Application Priority Data
Jul. 10, 2017 (GB) 1711052.9

(51) Int. Cl. G01C 21/34; G01C 21/36

(52) U.S. Cl. CPC G01C 21/3469; G01C 21/3492; G01C 21/3655; G01C 21/3697

(57) ABSTRACT

A system includes a route-optimization module configured to calculate an efficient route. The module is also configured to utilize modelled vehicle-efficiency data, reflecting expected performance, for determining route efficiency and project driver-specific efficiency along a proposed route. The module is further configured to utilize efficiency-affecting vehicle state data to determine projected state efficiency-impact. The system also includes a guidance module configured to provide real-time guidance targets including gear selection and vehicle speed and provide real-time feedback to the driver comparing observed vehicle performance to the guidance targets.

### CROSS-REFERENCE TO RELATED APPLICATIONS

This application claims foreign priority benefits under 35 U.S.C. § 119(a)-(d) to GB Application 1711052.9 filed Jul. 10, 2017, which is hereby incorporated by reference in its entirety.

### TECHNICAL FIELD

The illustrative embodiments relate to a system for optimizing driver and vehicle performance, including, although not limited to, calculating the most economical route to an input destination and providing real time driver guidance.

### BACKGROUND

Satellite navigation systems may provide a driver with the option to select the shortest or the fastest route to a given destination. Live systems that are connected to a network may provide automatic routing to avoid traffic congestion or incidents and can update the route during the journey without driver interaction. It is also possible for the driver to instruct the system to avoid certain types of roads because one calculated route may guide the driver onto an unsuitable road.

Different routes may require different driving styles. For example, when driving on roads with lots of tight bends or inclines, the driver is required to repeatedly brake and accelerate, which can have a negative effect on vehicle fuel economy. Conversely, when driving on multi-lane roads at a steady speed the vehicle has a far greater fuel economy if driven in the correct manner.

The same principle applies in relation to electric vehicles. In conditions where the vehicle repeatedly brakes and accelerates, the battery will be depleted quicker than if the vehicle is driven at a substantially continuous speed.

Furthermore, autonomous vehicles, particularly electric autonomous vehicles, may have a very limited range. It is therefore useful if the routes of such vehicles are carefully planned to ensure that the vehicle has enough fuel or battery charge to complete its journey or stop at a fuel station/charge point. Autonomous vehicles, while potentially monitored, are not driven by a person. Thus, there is limited opportunity to address fuel shortage or depleted batteries if the vehicle's route is not carefully planned.

The functionality provided by most route planning algorithms is generally quite basic and does not take into account driver, vehicle or environment specific factors. Accordingly, it is common for the driver to simply accept the shortest or quickest route calculated by a satellite navigation system. Even if a route is the shortest or quickest route it does not automatically translate to the cheapest or best route in terms of fuel economy.

### SUMMARY

An aspect of the illustrative embodiments provides a system for optimizing driver and vehicle performance. The system may include a route optimization module configured to calculate a route to an input destination based on driver priorities, wherein the route optimization module is configured to utilize modelled vehicle performance variables in the route calculation, wherein the route optimization module is further configured to use a driver identity data, and wherein the route optimization module is further configured to utilize vehicle state data; and a driver guidance module configured to provide real time guidance to the driver including gear selection and vehicle speed, wherein the driver guidance module is further configured to provide real time feedback to the driver relating to the performance of the vehicle based on observed driver behavior.

How a vehicle is driven can drastically affect fuel economy and emissions, and other performance variables. For example, a vehicle having a specified fuel economy of 55 miles per gallon during extra urban driving will only achieve this when the vehicle is driven at a certain speed in a certain gear without the need to brake or accelerate. Factors of a vehicle's performance, i.e. fuel economy, can be maximized by selecting a route to an input destination that takes into account factors such as the modelled fuel economy for a selection of routes, vehicle state data and driver data. Using this information in a calculation to select the most appropriate route is thus useful in maximizing vehicle fuel economy. Even given a specific route, fuel economy will differ depending on driving style and vehicle type. Once the specific vehicle's fuel economy is modelled for a particular route, driving instructions are communicated to the driver in order to seek real time fuel economy as close as possible to the modelled fuel economy.

The system may further comprise a communication module configured to interface with a network and receive real time updates relating to traffic conditions and incidents on the route, wherein the communication module is operably connected to the route optimization module and the route optimization module is configured to calculate a new route to avoid any such traffic congestion or incident on the route where such new route is modelled to provide a greater vehicle performance than calculated for the original route.

Provision of real time data on the selected route and using this data to continually monitor whether the selected route would provide the greatest performance or meet driver priorities enables the system to calculate a new route once the communication module has received real time information relating to traffic or weather conditions, for example. The communication module in conjunction with the route optimization module enables a dynamic route selection to take into account environmental variables.

Another aspect of the illustrative embodiments provides a system for optimizing automated vehicle performance, the system comprising a control hub in communication with a plurality of autonomous vehicles and respective route optimization modules associated with each of the plurality of autonomous vehicles, wherein each route optimization module is configured to calculate a route to an input destination based on driver priorities, wherein each route optimization module is configured to utilize modelled vehicle data in the route calculation and wherein each route optimization module is further configured to utilize vehicle state data, and wherein the vehicle is configured to maintain a target performance along the route.

To optimize operational time of autonomous vehicles it is important to carefully plan the vehicle's route to maximize run time while maintaining enough fuel/battery charge in reserve to account for unplanned variables such as an accident. By using modelled fuel economy, for example, the vehicle's route can be planned to utilize a substantial portion of the vehicle's fuel/battery charge without risking breakdown due to fuel shortage/depleted battery. Furthermore, by driving the vehicle to maintain a target fuel economy along the route the vehicle's range can be maximized.

Another aspect of the illustrative embodiments provides a system for optimizing driver and vehicle performance, the system comprising a route optimization module configured to calculate a route to an input destination based on driver priorities, wherein the route optimization module is configured to utilize modelled vehicle data in the route calculation, and a driver guidance module configured to display real time vehicle performance and modelled vehicle data and wherein the driver guidance module is further configured to provide driver instructions in order to assist the driver in matching the real time vehicle performance to the modelled vehicle data.

Provision of data relating to real time vehicle performance and modelled vehicle data provides a simple comparison for the vehicle driver and a target for the driver to aim for. It has been proven in many applications that gamification acts as in incentive for encouraging certain actions. This aspect of the invention thus provides motivation for the driver to drive the vehicle in a manner which has optimum fuel economy.

Another aspect of the invention provides a method of optimizing driver and vehicle performance, the method comprising: i) modelling one or more vehicle performance variables, ii) using the modelled variables to calculate one or more routes to an input destination, iii) selecting the route modelled to have the greatest performance for a given variable, iv) communicating driving instructions to a driver to optimize vehicle performance for the given variable.

The step of modelling performance of the vehicle may comprise utilizing one or more parameters selected from the groups including: vehicle parameters, user input variables, user priorities, user route input and real time data input.

The method may further include the step of sending data relating to actual vehicle performance and/or associated driving parameters to a remote server.

Data regarding actual vehicle performance in relation to a specific route or a portion of a specific route can be used to refine the algorithms used to calculate routes in accordance with the present invention. Furthermore, associated driving parameters can be used to exclude data relating to outlier performance readings where, for example, the vehicle has a naturally poor fuel economy or where the vehicle has been driven in a manner where performance was not a priority.

The illustrative embodiments will now be described by way of reference to the following figures.

### BRIEF DESCRIPTION OF THE DRAWINGS

FIG. 1 shows a system for optimizing driver and vehicle performance according to an embodiment of the invention;

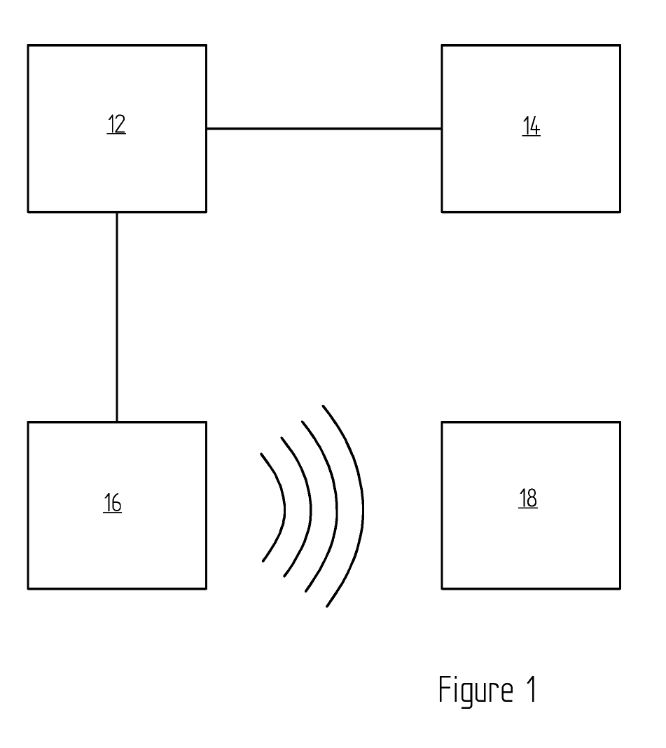

FIG. 2 shows a method of optimizing driver and vehicle performance according to an embodiment of the invention.

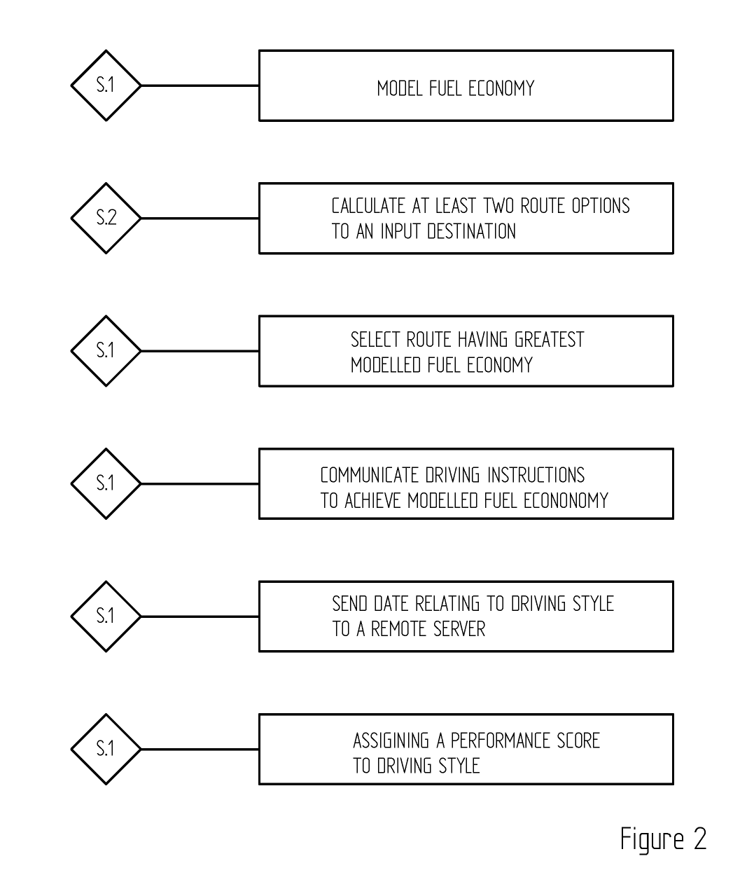

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle comprising a system for optimizing driver and vehicle performance according to the present invention comprises a route optimization module (12) for calculating a route based on an input destination, a driver guidance module (14) for conveying suggested driving instructions to the driver to meet a target fuel economy and a communications module (16) for enabling real time traffic updates to be relayed to the route optimization module (12). Upon determination of traffic congestion or an incident on the calculated route, the system continually monitors alternative routes to determine which route provides the quickest journey time and/or greatest modelled fuel economy, for example. If an alternative route more closely matches the selected variables for the journey, they system will re-calculate the route to guide the driver along the re-calculated route.

The route optimization module (12) uses a number of factors to calculate a route to an input destination. Such factors can be grouped as follows: vehicle variables, driver input variables, driver optimization priorities, driver route input, real time traffic data input and real time changes to any of the foregoing.

Vehicle variables include, but are not limited to, vehicle model and body style, e.g. hatch back or saloon, presence of start/stop technology, transmission type, i.e. manual or automatic, tire type, tire depth, tire pressure, fuel level, battery state of charge, ambient external temperature, air conditioning state, i.e. on/off, smart acceleration control state and speed limiter state.

Driver input variables include, but are not limited to, number of passengers, estimated passenger weight, estimated luggage weight, trailer loading, roof rack loading, bike rack loading.

Driver optimization priorities include, but are not limited to, fuel economy, NOx, HC and/or CO particulate emissions, time to destination, start time, finish time, finish point.

Driver router inputs include, but are not limited to, start point, way points, finish point, start time and finish time.

Real time data input categories include, but are not limited to, traffic conditions, fuel station locations and prices, battery charging locations and prices, route topography, weather conditions and traffic incidents.

Vehicle variables and driver input variables are combined by the route optimization module to generate a CAE model of the vehicle including, for example, vehicle weight, fuel type and level, NOx, HC and CO emissions, gearing efficiency and fuel efficiency.

Each of the above features (where present) is used by the route optimization module to calculate a route to an input destination that provides the greatest modelled fuel economy.

The route optimization module (12) is operably connected to the driver guidance module (14). The driver guidance module (14) at its basic level provides directions to the input destination in the manner of conventional satellite navigation systems. Furthermore, to aid the driver in meeting the modelled fuel economy, the driver guidance module (14) also provides one or more of the following outputs or driver aids: SDM mode recommendation, speed target, gear target, acceleration rate target, planned or recommended rest (or taco) stops, required fuel stops or battery recharge stops, driver scoring vs targets and status of optimization choice.

The driver guidance module (14) is operably connected to the communication module (16). In addition to receiving real time traffic updates the communication module (16) uploads data collected by the driver guidance module (14) (or route optimization module (12)) to a remote server (18) which may be cloud based. Examples of the data uploaded by the communication module (16) include: driver style, vehicle usage pattern, on road fuel economy and emissions, driver adaptation and driver priorities.

In certain embodiments, the system assigns a performance score following completion of a journey based on the driver's ability to match driving style to communicated driving instructions. Effectively, the score is based on the correlation of modelled fuel economy to real time fuel economy.

The illustrative embodiments are also applicable to autonomous vehicles where instead of a driver guidance module, data is transmitted from the route optimization module (12) to a vehicle control unit (not shown). Examples of such data include, but are not limited to, route, speed, charging, recharge/refuel stops and feedback to a centralized vehicle control hub. The centralized control hub controls the input destination and journey parameters for each autonomous vehicle.

The foregoing description is not intended to limit the scope of the invention and is given by way of example only. The description should be used simply to interpret the claims without undue limitation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a route-optimization module configured to:
calculate an efficient route,
utilize modelled vehicle-efficiency data, reflecting expected performance, for determining route efficiency,
project driver-specific efficiency along a proposed route,
utilize efficiency-affecting vehicle state data to determine projected state efficiency-impact, and
a guidance module configured to:
provide real-time guidance targets including gear selection and vehicle speed, and
provide real time feedback to a driver comparing observed vehicle performance to the guidance targets.

2. The system of claim 1, further comprising:
a communication module configured to interface with a network and receive real time updates relating to traffic on the proposed route, wherein the communication module is communicably connected to the route-optimization module, and wherein the route-optimization module is further configured to calculate a new route responsive to traffic, and utilize the new route when the new route provides greater vehicle efficiency than calculated for the proposed route.

3. The system of claim 2, wherein the guidance module is communicably connected to the communication module and configured to transmit data relating to the observed vehicle performance, including vehicle characteristics, driver characteristics, or vehicle usage, to a remote server.

4. The system of claim 1, wherein vehicle state data includes one or more of: vehicle model, vehicle body type, engine start/stop status, vehicle transmission, tire type, tire pressure, tire depth, fuel level, charge status, ambient temperature, air conditioning state, smart acceleration control state, speed limiter state, modelled gearing and efficiencies, instantaneous emissions measurement and vehicle payload.

5. The system of claim 1, wherein the route-optimization module is further configured to utilize user input variables including one or more of number of passengers, trailer status, roof rack status, luggage status, and bike rack status to project efficiency.

6. The system of claim 1, wherein the route-optimization module is further configured to utilize predefined user priorities including one or more of fuel economy, vehicle emissions, journey time, journey distance, and journey cost.

7. The system of claim 1, wherein the route-optimization module is further configured to utilize user route inputs including journey start point, way points, journey end point, journey start time, and journey finish time.

8. The system of claim 2, wherein the route-optimization module is further configured to utilize real-time data inputs received by the communication module and wherein the real-time data inputs include one or more of traffic conditions, fuel station locations and price, battery charging locations and price, route topography, weather conditions, and road works/accidents.

9. The system of claim 1, wherein the guidance module is further configured to provide one or more of a driving mode recommendation, an acceleration rate target, rest/fuel stop recommendations, and driver scoring based on optimization status derived from the comparison.

10. A system comprising:
a route optimization module configured to:
calculate a route,
utilize modelled vehicle efficiency-data in the route calculation, and
a driver guidance module configured to:
display real-time vehicle performance and modelled vehicle efficiency-data reflecting desired performance, and
provide real-time driver instructions during travel along the route to assist a driver in matching the real-time vehicle performance to the modelled vehicle efficiency-data.

11. The system of claim 10, wherein the modelled vehicle efficiency-data reflects expected efficiency based on route variables including topography, road type, road surface, traffic conditions, and ambient temperature.

12. The system of claim 10, wherein the driver guidance module is further configured to provide a performance score calculated based on a driver's ability to match the real-time vehicle performance to the modelled vehicle efficiency-data and to follow driver instructions provided by the driver guidance module.

13. A computer-implemented method comprising:
i) modelling vehicle performance variables affecting fuel economy of a vehicle;
ii) using the modelled fuel economy variables to calculate efficiency of a plurality of routes to a common destination;
iii) selecting the route projected to have greatest fuel economy performance for a given variable; and
iv) repeatedly communicating vehicle-utilization instructions to a driver to optimize fuel economy vehicle performance, based on the modelled variables, over the selected route.

14. The method of claim 13, further comprising sending data relating to actual vehicle performance and associated driving parameters to a remote server.

15. The method of claim 13, further comprising assigning a driver score calculated as a function of modelled vehicle efficiency-data and actual vehicle performance observed over a journey.
